(19) United States
(12) Patent Application Publication
(10) Pub. No.: US 2020/0019405 A1
(43) Pub. Date: Jan. 16, 2020

(54) Multiple Level History Buffer for Transaction Memory Support

(71) Applicant: International Business Machines Corporation, Armonk, NY (US)

(72) Inventors: Steven J. Battle, Austin, TX (US); Joshua W. Bowman, Austin, TX (US); Dung Q. Nguyen, Austin, TX (US); Albert J. Van Norstrand, JR., Round Rock, TX (US); Cliff Kucharski, Austin, TX (US); Hung Q. Le, Austin, TX (US); Brian D. Barrick, Pflugerville, TX (US)

(73) Assignee: International Business Machines Corporation, Armonk, NY (US)

(21) Appl. No.: 16/035,676

(22) Filed: Jul. 15, 2018

(51) Int. Cl. G06F 9/38; G06F 9/46; G06F 9/30; G06F 12/0897

(52) U.S. Cl. CPC G06F 9/3806; G06F 9/3832; G06F 12/0897; G06F 9/30141; G06F 9/467

(57) ABSTRACT

A split level history buffer in a central processing unit is provided. The history buffer includes first, second, and third levels, each having different characteristics. Operational instructions are provided to support the split history buffer. A first instruction is fetched, tagged, and stored in an entry of a register file. As a second instruction is fetched and tagged, the first instruction is evicted from the register file and stored in the first level of the history buffer. Similarly, as a result for the first instruction is generated, the first instruction and the generated result are stored in the second level of the history buffer. In response to instruction completion, instead of remaining in the second level, the first instruction, which contains pre-transactional memory checkpoint data, is moved from the second level to the third level of the history buffer, together with pre-transactional memory data, and the first instruction entry in the second level is invalidated.

### BACKGROUND

The present embodiments relate generally to the field of data processing systems. More specifically, the embodiments relate to history buffers and implementation of the history buffers in a central processing unit.

Central processing units (CPUs) may implement multi-threaded core technologies that utilize one or more execution lanes. Each execution lane utilizes a register file (RF) and a history buffer (HB) that contains architected register data. The HB is a component of an execution unit that preserves register contents when a register is a target of a newly dispatched instruction and the target register's contents require preservation, such as during a branch instruction.

Instructions are chronologically tagged, e.g. by the order in which they were fetched. Once the instructions are fetched and tagged, the instructions are then executed to generate results, which are also tagged. The RF may contain results from the most recently executed instructions, i.e. newer register data, and the HB may contain results from previously executed instructions, i.e. older register data. The older register data is displaced by newer register data from one or more entries in the RF to one or more entries of the HB. In some embodiments, a limited number of entries in the HB may reach a memory capacity and impact CPU performance.

There are physical limitations present with respect to configuration and use of the HB. Namely, each individual HB must contain one write port for each results bus. However, multiple write ports are expensive to implement in that the circuit area grows with each added write port. Accordingly, there is a need to balance the physical limitations of the circuit area with management of HBs and associated register data.

### SUMMARY

The embodiments described herein include a system, computer program product, and a method for processing instructions responsive to a split level history buffer in a central processing unit.

In one aspect, a computer system is provided with a central processing unit (CPU) having a history buffer split into multiple levels, including first, second, and third levels. The history buffer includes an associated history buffer (HB) controller with logic and/or program instructions for reading and writing data in the history buffer. Similarly, the CPU includes a register file and an associated register file (RF) controller with logic and/or program instructions for reading and writing data to the register file. The RF controller is configured to fetch a first instruction, and tag the fetched first instruction, and allocate space for the first instruction in an entry of a register file. The RF controller further fetches a second instruction, and tags the fetched second instruction. Thereafter, the RF controller evict the first instruction from the entry of the register file, allocates space for the second instruction in the entry of the register file, and communicates with the HB controller to store the first instruction in the first level of the history buffer. In response to generation of a result for the first instruction, the HB controller moves the first instruction from the first level of the history buffer, stores the generated result in the second level of the history buffer, and invalidates the entry of the first instruction in the first level of the history buffer. Responsive to instruction completion and identification of pre-transactional memory data contained in the first instruction, the HB controller moves the first instruction from the second level to the third level of the history buffer, with the moved first instruction including pre-transactional memory data. In response to movement of the first instruction to the third level of the history buffer, the HB controller invalidates the entry of the first instruction in the second level of the history buffer.

In another aspect, a computer program product is provided for processing instructions responsive to a split history buffer of a central processing unit (CPU). The computer program product comprises a computer readable storage device having program code embodied therewith, the program code executable by a processing unit. The history buffer is configured with multiple levels, including first, second, and third levels. A register file is configured with a register file (RF) controller configured with logic and/or program instructions to read and write instructions to the register file. Similarly, the history buffer is configured with an associated controller, referred to as a history buffer (HB) controller, with logic and/or program instructions to read and write data to the history buffer. Program instructions are provided and managed by the RF controller to fetch a first instruction, tag the fetched first instruction, and allocate space for the first instruction in an entry of a register file, and to fetch a second instruction, tag the fetched second instruction, evict the first instruction from the entry of the register file, and allocate space for the second instruction in the entry of the register file. Program instructions are provided and managed by the HB controller to allocate space for the first instruction in the first level of the history buffer. In response to generation of a result for the first instruction, the HB controller logic will move the first instruction from the first level of the history buffer, and allocate space for the first instruction, including the generated result, in the second level of the history buffer. Responsive to movement of the first instruction to the second level of the history buffer, the HB controller logic invalidates the entry of the first instruction in the first level of the history buffer. Similarly, in response to instruction completion and identification of pre-transactional memory data contained in the first instruction, the HB controller logic moves the first instruction from the second level to the third level of the history buffer. Responsive to movement of the first instruction to the third level of the history buffer, the HB controller logic invalidates the entry of the first instruction in the second level of the history buffer.

In yet another aspect, a method is provided for processing instructions responsive to a split history buffer of a central processing unit (CPU). The history buffer is configured with multiple levels, including first, second, and third levels. A first instruction is fetched, tagged, and space for the first instruction is allocated in an entry of a register file. Similarly, a second instruction is fetched and tagged. The first instruction is evicted from the entry of the register file. In addition, space is allocated in the entry of the register file for the second instruction, and the first instruction is stored in the first level of the history buffer. Responsive to generating of a result for the first instruction, the first instruction is moved from the first level of the history buffer, which further includes storing the first instruction and the generated result in the second level of the history buffer and invalidating the entry of the first instruction in the first level of the history buffer. Similarly, responsive to instruction completion, the first instruction is moved from the second level to the third level of the history buffer, which further includes moving first instruction including pre-transactional memory data. Finally, responsive to movement of the first instruction to the third level of the history buffer, the entry of the first instruction in the second level of the history buffer is invalidated.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 depicts a block diagram illustrating a system diagram of a computing environment with a split history buffer.

FIG. 2 depicts a flow chart illustrating operational steps performed by the computer system for transaction processing in conjunction with the split history buffer.

FIG. 3 depicts a flow chart illustrating operational steps performed by the computer system for moving data from the L1 level to the L2 level.

FIG. 4 depicts a flow chart illustrating operational steps performed by the computer system for moving data from the L2 level to the L3 level.

FIG. 5 depicts a flow chart illustrating operational steps performed by the computer system for completion of the transaction.

FIG. 6 depicts a flow chart illustrating operational steps performed by the computer system for data movement across the split history buffer after a TM fail.

FIG. 7 depicts a block diagram illustrating internal and external components of the computer system shown in FIG. 1.

### DETAILED DESCRIPTION

It will be readily understood that the components of the present embodiment, as generally described and illustrated in the Figures herein, may be arranged and designed in a wide variety of different configurations. Thus, the following detailed description of the embodiments of the apparatus, system, and method, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment of the present embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

The embodiments shown and described below provide efficient and cost-effective systems and methods for managing architected register data within central processing units. A split history buffer is implemented, including a first level history buffer (L1), a second level history buffer (L2), and a third level history buffer (L3). Each of the history buffers have a specific design characteristic and function that is cognizant of limited circuit design space.

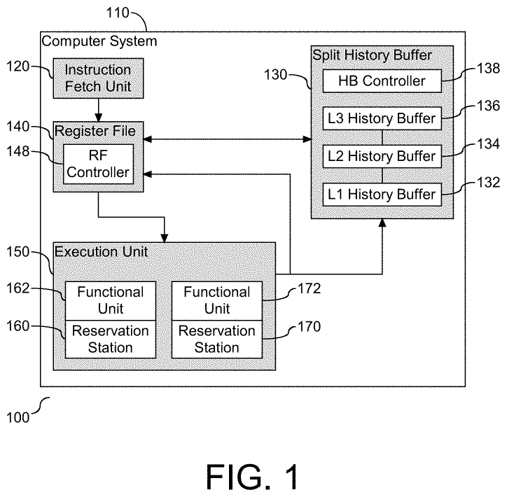

Referring to FIG. 1, a system diagram (100) is provided illustrating a computing environment with a split history buffer. As shown, the environment (100), such as a processor or multiprocessor, includes an architecture that utilizes an execution unit and a split history buffer. The environment (100) is shown with a computer system (110) configured with an instruction fetch unit (120), register file (140), execution unit (150), and a split history buffer (130) including a first level, L1, history buffer (L1) (132), a second level, L2, history buffer (L2) (134), and third level, L3, history buffer (136). As shown, a history buffer controller (138), hereinafter referred to herein as HB controller, is operatively coupled to the levels (132)-(136), and includes logic and associated program instructions to implement a control algorithm for moving data from L1 (132) to L2 (134), and from L2 (134) to L3 (136). The HB controller (138) sends signals to the L1 (132), L2 (134), and L3 (136) levels to read or write entries, depending on the movement, and as described in detail below. In one embodiment, each level of the history buffer is a separate array, including L1 (132) being a first array, L2 (134) being a second array, and L3 (136) being a third array. In one embodiment, additional components (not shown) may be implemented by the computer system (110) that perform operations, such as arithmetic, logical, control, input/output (I/O), etc., to facilitate CPU functionality. It should be understood that the environment (100) may include additional computer systems (110), a network, or other devices (not shown). The embodiments shown and described herein may be performed by the system (110), or by a module performing operations in the computing environment (100).

Instruction fetch unit (120) fetches one or more instructions from program memory (not shown), and transmits the one or more fetched instructions and a unique multi-bit ITAG, i.e. a mechanism used to tag or identify instructions, tagging each of the one or more fetched instructions to register file (140), e.g. storing the instructions as an entry in the register file (140). Each of the one or more fetched instructions is represented by a numeric string describing an operation to system (110) to execute. In one embodiment, instruction fetch unit (120) may utilize a program counter (not shown) to tag each of the one or more fetched instructions. For example, three instructions fetched from program memory may be tagged by three unique multi-bit ITAGs indicating an order in which the three instructions were fetched. In one embodiment, instruction fetch unit (120) may include a decoding component to partition the fetched instructions for subsequent execution. In a further embodiment, the instruction fetch unit (120) may support branch prediction.

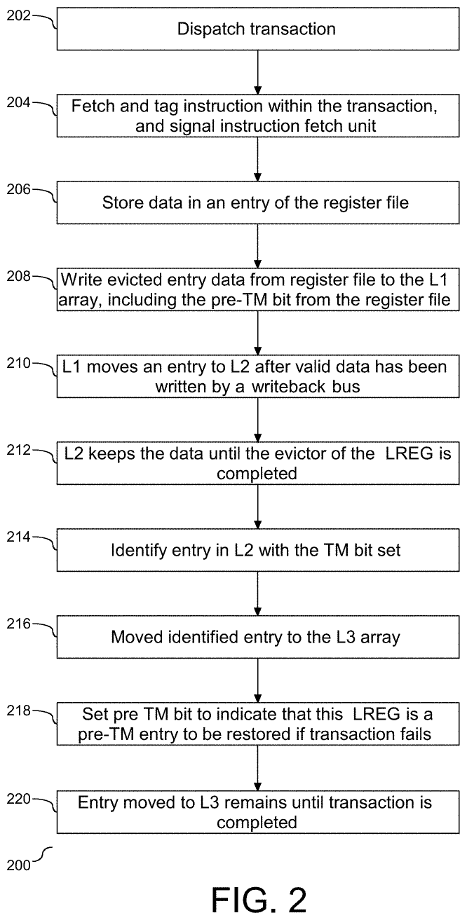

Register file (140) contains the one or more fetched instructions prior to dispatching each of the one or more fetched instructions to execution unit (150). In one embodiment, the register file (140) is an array of processor registers having one or more entries available to store the one or more fetched instructions. As shown, the register file (140) includes a register file controller (148), hereinafter referred to as RF controller, to implement logic and associated program instructions for writing entries into the register file array and reading the entries out of the register file array when evicting to the history buffer (130). It is understood that the register file (140) may have an older instruction entry. Every instruction evicts the ‘prior’ data. In an example with only two instructions and both instructions targeting the same register, the second instruction evicts ‘prior data’ written by the first instruction. However, in this same two instruction example, if the first and second instructions target different registers, e.g. first and second registers, then the second instruction will not evict the first instructions. Each of the first and second instructions will evict whatever prior data was in the respective register file. Each entry of the register file (140) contains at least, a fetched instruction tagged by an ITAG and the ITAG. Entry data of an entry in the register file (140) may be evicted to the split history buffer (130) through logic associated with the RF controller (148), as shown and described in FIG. 2. Contents of an entry in the register file (140) may also include result data. In one embodiment, more than one register file (140) may be implemented by system (110) and configured as a register bank.

The execution unit (150) produces and generates a result for each of the one or more tagged instructions dispatched by the register file (140), e.g. dispatched by the RF controller (148). In one embodiment, the execution unit (150) generates a result for a tagged instruction by performing operations and calculations specified by operation code of the tagged instruction. Execution unit (150) includes functional unit (162) and functional unit (172), which corresponds to reservation stations (160) and (170), respectively. In one embodiment, execution unit (150) and components therein are each connected, such that each component is configured to perform at least a portion of a desired operation during a clock cycle.

Reservation stations (160) and (170) enable the system (110) to process and execute instructions out of order. In one embodiment, reservation stations (160) and (170) facilitate parallel execution of instructions. For example, reservation stations (160) and (170) permit system (110) to fetch and re-use a data value once the data value has been computed by one or both of functional units (162) and (172). In one embodiment, the system (110) uses reservation stations (160) and (170) so that the system (110) does not have to wait for a data value to be stored in the split history buffer (130) and re-read. In one embodiment, reservation stations (160) and (170) are connected to functional units (162) and (172), respectively, for dynamic instruction scheduling. Furthermore, reservation stations (160) and (170) may enable the system (110) to have advanced capabilities for processing and executing one or more tagged instructions. Reservations stations (160) and (170) may contain necessary logic used to determine a manner to execute a tagged instruction once the tagged instruction is dispatched from register file (140).

Functional units (162) and (172) output result data for tagged instructions dispatched from register file (140). In one embodiment, functional unit (162) executes tagged instructions to generate a result for the tagged instruction. The functional unit (172) executes the other tagged instruction to generate another result for the other tagged instruction. In one embodiment, functional units (162) and (172) are components, e.g. adders, multipliers, etc., connected to reservation stations (160) and (170), respectively. For example, functional units (162) and (172) may be arithmetic logic units (ALUs) or floating point units (FLUs). In another embodiment, functional units (162) and (172) may generate a plurality of results in parallel, independently, and/or sequentially. Similarly, in one embodiment, additional functional units and associated reservation stations may be implemented in the system (110), and as such, the quantity shown and described herein should not be considered limiting.

As shown, the split history buffer (130) is comprised of three levels, including the L1 (132), L2 (134), and L3 (136). The levels (132)-(136) contain one or more entries storing data from register file (140). The configuration of the split history buffer (130), e.g. L1 (132), L2 (134), and L3 (136), is a history buffer that has been partitioned into three levels, e.g. levels, to effectively increase a number of entries in the split history buffer (130) containing one or more tagged instructions and additional information for the one or more tagged instructions. System (110) utilizes the levels (132)-(136) to store one or more tagged instructions and additional information for each of the one or more tagged instructions. Each entry data evicted from register file (140) are stored in the split history buffer (130) prior to the system (110) performing a subsequent action, e.g. completion, flushing, restoration, etc. System (110) utilizes logic and other signals to ensure that L1 (132), L2 (134), and L3 (136) contain evicted entry data in a correct chronological order.

Each level in the split history buffer has associated characteristics and functionality. The L1 and L2, (132) and (134), respectively, support main line execution and performance profile. The L3, (136), is configured to support Transactional Memory (TM). It is understood in the art that TM is a shared-memory synchronization constructions that allows process-threads to perform storage operations that appear to be atomic to other process-threads or applications. TM is a construct that allows execution of lock-based critical sections of code without acquiring a lock. The L1 (132) includes all the write ports necessary to sink multiple writeback buses. The L1, (132), moves an entry to the L2, (134), only after the valid data has been written by the writeback buses. Responsive to movement of the L1 (132) entry to the L2 (134), the HB controller (138) invalidates the entry in the L1 (132). All writeback ITAG compares occur on a fewer number of L1 (132) entries. The L2 (134) is configured with less write ports than the L1 (132). In one embodiment, the L2 (134), is configured with one write port each for the number of entries that can be moved from the L1 (132) to the L2 (134) in any given cycle. Similarly, in one embodiment, the L2 (134) is sized just large enough to support in-flight execution while not in a TM mode.

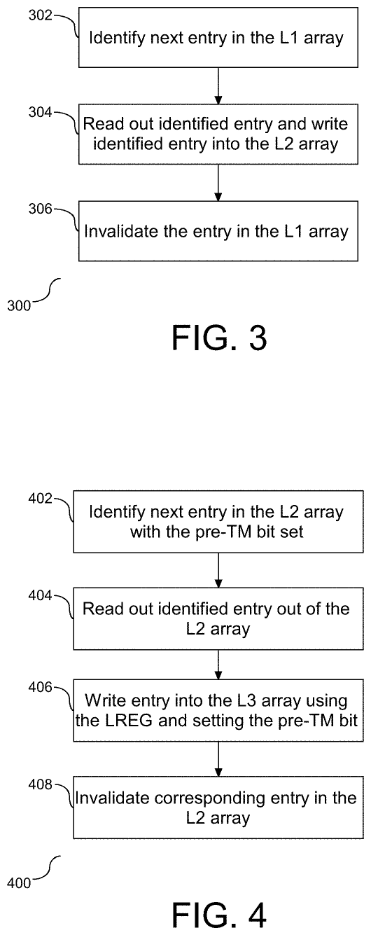

The L3 (136) is configured to contain all pre-TM states after instruction completion. Data can move from the L2 (134) to the L3 (136) when the core is executing a TM code and the pre-TM states are already completed and removed from an associated completion table; the L3 (136) is idle in all other modes. The L3 (136) is physically configured to contain data for all architected logical registers (LREGs) for general purpose registers (GPRs) and vector and scalar registers (VSRs). It is understand that an associated transaction either passes or fails. If the transaction passes, then all pre-TM data in the L3 (136) can be discarded, and if the transaction fails, then valid L3 (136) entries can be read out and restored to the main register table. There is only one entry per LREG in the L3 (136). Since the L3 (136) only contains completed pre-TM data, the L3 (136) does not need write back, completion support, or flush support. Details of the functionality of the L3 (136) are shown and described in FIG. 3.

Referring to FIG. 2, a flow chart (200) is provided illustrating operational steps performed by computer system (110) for transaction processing in conjunction with the split history buffer. As shown, a transaction is dispatched (202), and all LREGs in the register file are marked to indicate that the LREGs are dispatched before the transaction. In one embodiment, the marking is in the form of setting a pre-TM bit, e.g. bit set to 1. The pre-TM bit for an entry is written into the L1 history buffer when the entry is evicted from the register file. The pre-TM bit is written into the L2 history buffer when the entry is evicted from the L1 history buffer. The system fetches a first instruction within the transaction, tags the instruction with an ITAG, and signals the instruction fetch unit to dispatch the ITAG and the tagged first instruction to the register file (204). The system allocates space for the tagged first instruction and the ITAG for the first tagged first instruction in an entry of the register file (206). In one embodiment, the entry of the register file contains older data, e.g. tagged instruction and an ITAG for the tagged instruction dispatched at an earlier time. This older entry will have pre-TM bit set to 1. The register file evicts the older entry data to make the entry available, and subsequently allocate space for the tagged first instruction and ITAG for the tagged first instruction. The system writes the evicted entry data, e.g. the older entry data that was evicted from an entry of the register file, to an entry in the L1 (208) and includes the pre-TM bit from the register file. As shown in FIG. 1, the result data for the L1 entry is written by the execution unit. In one embodiment, the system includes an evictor ITAG in the entry of the L1 containing the evicted entry data. Similarly, in one embodiment, the entry of the register file may not contain older entry data, e.g. the entry in the register file is empty, in which case, the system stores the tagged first instruction and ITAG for the tagged first instruction in the empty entry in the register file. Accordingly, the L1 supports main line execution and performance profile, and as shown herein, older data in the register file may be evicted to the L1 to make room for new data in the register file.

The L1 (132) is a first level history buffer with one or more entries containing evicted entry data. In one embodiment, evicted entry data are transmitted from the register file (140) to the L1 (132) responsive to an eviction operation, as shown and described in FIG. 2. In one embodiment, each entry of the L1 (132) containing evicted entry data includes at least one ITAG for a first tagged instruction, the first tagged instruction, an evictor ITAG, and additional status bits, i.e. information describing completion status, flushing, etc. The phrase “evictor ITAG” as used herein, refers to an ITAG for a second tagged instruction that evicted entry data from an entry of register file (140) to an entry in L1 (132). In one embodiment, an entry of L1 (32) may also contain result data generated from the execution unit (150). For example, the system (110) may issue a “set data_v=1” in control logic to indicate successful generation of a result, e.g. an indication of an entry in the level with valid data.

The L2 (134) contains flush and complete compares. More specifically, the L1 moves an entry to the L2 after valid data has been written by a writeback bus (210). Referring to FIG. 3, a flow chart (300) is provided illustrating operational steps performed by computer system (110) for moving data from the L1 level to the L2 level. As shown, the next entry in the L1 level with an indication that the entry has valid data, e.g. data_v=1, is identified (302). The identified entry is read out of the L1 level and written into the L2 level (304) via the HB controller (138), followed by invalidating the entry in the L1 level (306) also via the controller (138). The step of invalidating the entry from the L1 frees up space in the L1 level to receive new instructions. The steps shown herein are conducted sequential per cycle. Movement of the entry from the L1 to the L2 includes a generated result of the first instruction and an associated pre-TM bit. Accordingly, as shown, data are transmitted from the register file (140) to the L1 (132), and from the L1 (132) to the L2 (134).

The L2 level keeps the data until the evictor of the LREG is completed (212). Referring to FIG. 4, a flow chart (400) is provided illustrating operational steps performed by computer system (110) for moving data from the L2 level to the L3 level. The next entry in the L2 level with the pre-TM bit set, e.g. pre-TM=1, and an indication that the associated instruction is no longer speculative, e.g. its evictor ITAG is completed, is identified (402). The identified entry is read out of the L2 level (404), and written into the L3 level using the LREG and setting the pre-TM bit, e.g. pre_TM=1, (406). The LREG is known from the entry in the L2 level. The pre-TM bit is set so that the entry in the L3 level is identified as an active entry, e.g. an indication that the LREG is a pre-TM entry to be restored if the transaction fails. Following step (406), the corresponding entry in the L2 level is invalidated (408), thereby creating space in the L2 level for use by another entry from the L1 level. When an entry in the L2 (134) with a pre-TM bit set is completed, e.g. both the evictor and its own ITAG are completed, the entry cannot be flushed out. This entry can be moved to the L3 (136) until the transaction end, e.g. T_{end}, is completed.

An entry in the L3 does not contain flush or complete logic, e.g. the L3 (136) is not speculative. The L3 (136) supports TM, and is limited to pre-TM data. There is only one entry per LREG in the L3 (136). Following step (212) an entry in the L2 with the pre_TM bit set, e.g. the evictor and its own ITAGs are completed, is identified (214) and moved to the L3 (216). At step (216) the pre-transactional memory data contained in the L2 entry is verified prior to movement to the L3. The LREG of the entry is used as an index address to write into the L3. After the entry is written, its pre TM bit is set to 1 to indicate that this LREG is a pre TM entry to be restored it the transaction fails (218). The entry moved to the L3 level remains in the L3 until the transaction end, e.g. T_{end}, is completed (220). Accordingly, entries are selectively moved from the L2 level to the L3 level, and for each moved entry the associated entry in the L2 level is invalidated.

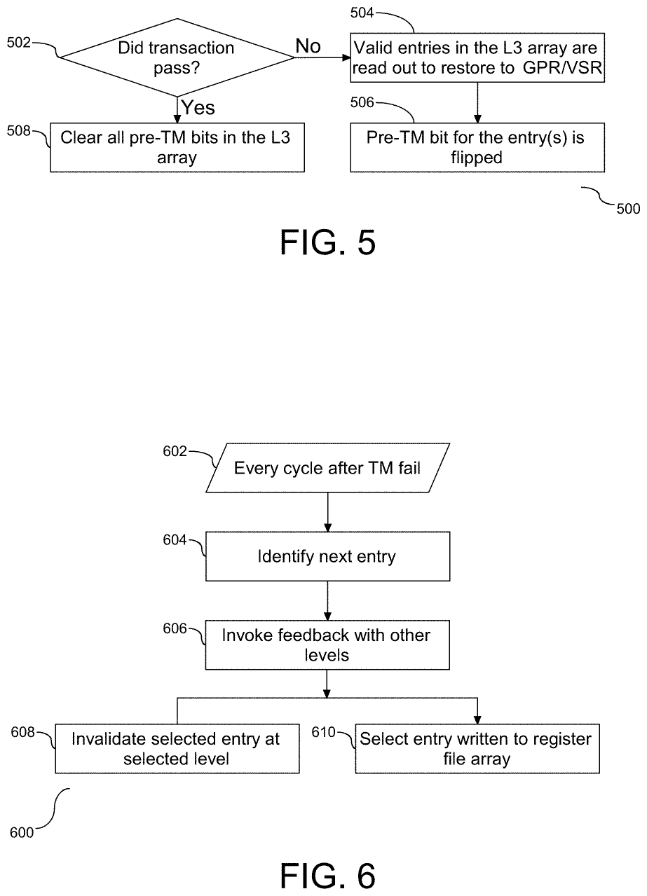

As shown in FIGS. 2-4, each level in the history buffer, e.g. L1, L2, and L3, has a specific design and function. As entries are selectively moved across the associated levels, prior entries are invalidated to make room for new entries. The entries remaining in the L3 are non-speculative and remain in the L3 until the transaction is completed. Referring to FIG. 5, a flow chart (500) is provided illustrating operational steps performed by computer system (110) for completion of the transaction, T. Completion is indicated by a pass or fail. As shown, it is determined in the transaction passed (502). If the transaction fails, the valid entries in the L3 are read out to restore the GPR/VSR (504). More specifically, at step (504) all entries with the pre TM bit set are written back to the GPR/VSR and restored to the main register table. After an entry is read out of the L3 to restore, the pre_TM bit for that row, e.g. entry, is set to 0, e.g. the bit is flipped, to indicate that the data in the L3 is no longer needed (506). If the transaction passed, e.g. the T_{end} completed with a pass indicator, all pre-TM bits in the L3 level are cleared out to indicate that these data are no longer need to be restored (508). In one embodiment, the bit is flipped in the L3 to invalidate the entries. Accordingly, the entries in the L3 are processed following transaction completion, with the processing based on a pass/fail assessment of the transaction.

Referring to FIG. 6, a flow chart (600) is provided illustrating operational steps performed by computer system (110) for data movement across the split history buffer after a TM fail. For every processor cycle after a TM fail (602), the next entry with the TM bit set is identified (604). The entry may be in any level, e.g. L1, L2, or L3, of the history buffer. In one embodiment, all three levels of the HB are searched in parallel. It is understood that more than one level may have identified the next entry, and only one entry is selected. A feedback mechanism is utilized to retain any other entries that may have been identified but not selected (606). The selected entry in the selected level of the split HB is invalidated (608). In parallel to the invalidation at step (608), the selected entry is written to the register file array (RF) (610). Accordingly, data movement following a TM fail searches all three levels in the history buffer for an entry with a restore pending.

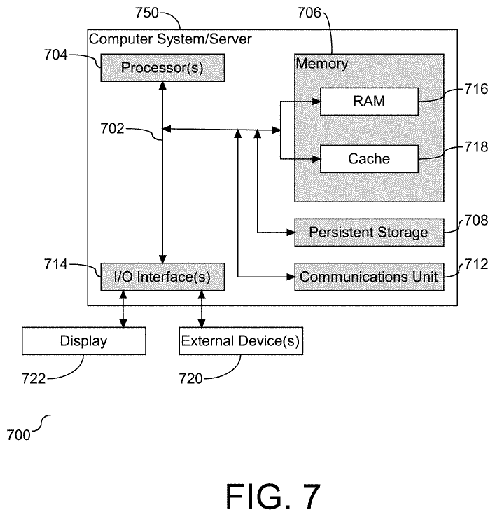

FIG. 7 is a block diagram (700) illustrating internal and external components of a computer system (750) in accordance with the embodiments shown and described herein. It should be appreciated that FIG. 7 provides only an illustration of one implementation and does not imply any limitations with regard to the environments in which different embodiments may be implemented. In general, the components illustrated in FIG. 7 are representative of any electronic device capable of executing machine-readable program instructions. Examples of computer systems, environments, and/or configurations that may be represented by the components illustrated in FIG. 7 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system (700) includes communications fabric (702), which provides for communications between one or more processors (704), memory (706), persistent storage (708), communications unit (712), and one or more input/output (I/O) interfaces (714). Communications fabric (702) can be implemented with any architecture designed for passing data and/or control information between processors (such as microprocessors, communications and network processors, etc.), system memory, peripheral devices, and any other hardware components within a system. For example, communications fabric (702) can be implemented with one or more buses.

Memory (706) and persistent storage (708) are computer-readable storage media. In an embodiment, memory (706) includes random access memory (RAM) (716) and cache memory (718). In general, memory (706) can include any suitable volatile or non-volatile computer-readable storage media. Software is stored in persistent storage (708) for execution and/or access by one or more of the respective processors (704) via one or more memories of memory (706). In this document, the terms “computer program medium,” “computer usable medium,” and “computer readable medium” are used to generally refer to media such as memory (706) and persistent storage (708).

Persistent storage (708) may include, for example, a plurality of magnetic hard disk drives. Alternatively, or in addition to magnetic hard disk drives, persistent storage (708) can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage (708) can also be removable. For example, a removable hard drive can be used for persistent storage (708). Other examples include optical and magnetic disks, thumb drives, and smart cards that are inserted into a drive for transfer onto another computer-readable storage medium that is also part of persistent storage (708).

Communications unit (712) provides for communications with other computer systems or devices via a network. In this exemplary embodiment, communications unit (712) includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments can be downloaded to a computer system through communications unit (712) (e.g., via the Internet, a local area network or other wide area network). From communications unit (712), the software and data can be loaded onto persistent storage (708).

One or more I/O interfaces (714) allow for input and output of data with other devices that may be connected to computer system (700). For example, I/O interface (714) can provide a connection to one or more external devices (720) such as a keyboard, computer mouse, touch screen, virtual keyboard, touch pad, pointing device, or other human interface devices. External devices (720) can also include portable computer-readable storage media such as, for example, thumb drives, portable optical or magnetic disks, and memory cards. I/O interface (714) also connects to display (722).

Display (722) provides a mechanism to display data to a user and can be, for example, a computer monitor. Display (722) can also be an incorporated display and may function as a touch screen, such as a built-in display of a tablet computer.

The present embodiments may be a system, a method, and/or a computer program product. The computer program product may include a computer readable storage medium (or media) having computer readable program instructions thereon for causing a processor to carry out aspects of the present embodiments.

The system shown and described above in FIG. 1 has been labeled with tools, including but not limited to the instruction fetch unit (120) and the execution unit (150). The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Computer programs (also called computer control logic) are stored in memory (706) and/or persistent storage (708). Computer programs may also be received via communications unit (712). Such computer programs, when run, enable the computer system to perform the features of the present embodiments as discussed herein. In particular, the computer programs, when run, enable the processor(s) (704) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to the various described embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles and the practical application of the embodiments, and to enable others of ordinary skill in the art to understand the embodiments with various modifications as are suited to the particular use contemplated. Accordingly, the implementation of the multi-level history buffer with different levels therein having specified functionality supports and enables reduced area on an associated substrate while supporting power consumption.

It will be appreciated that, although specific embodiments have been described herein for purposes of illustration, various modifications may be made without departing from the spirit and scope of the embodiments. In particular, in one embodiment the split history buffer may be implemented with a different quantity of levels. For example, the split history buffer may be configured with a first level, L1 similar to the L1 shown and described above, with a second level L2 dedicated to pre-transactional memory data, or the split history buffer may be configured with four levels, including a first level, L1, a second level, L2, a third level L3, and a fourth L4, with the L4 dedicated to pre-transactional memory data. In another embodiment, the third level, L3 of the history buffer dedicated to pre-transactional memory data may be in a different storage medium than the first and second levels, L1 and L2, respectively. For example, the pre-transactional memory data may be stored in the cache, scratch-pad memory, or in off-chip memory. The same movement algorithms would apply to control movement from the L2 level to the different storage medium of the L3. Accordingly, the scope of protection of these embodiments is limited only by the following claims and their equivalents.

What is claimed is:

1. A central processing unit (CPU), comprising:
a history buffer with a history buffer (HB) controller, the history buffer having multiple levels, including first, second, and third levels;
a register file and an associated register file (RF) controller;
the RF controller having logic to process instructions, the logic to:
fetch a first instruction, tag the fetched first instruction, and allocate space for the first instruction in an entry of the register file; and
fetch a second instruction, tag the fetched second instruction, evict the first instruction from the entry of the register file, allocate space for the second instruction in the entry of the register file;
the HB controller to:
receive the first instruction from the RF controller and store the first instruction in the first level of the history buffer;
responsive to generation of a result for the first instruction, move the first instruction from the first level of the history buffer, and store the first instruction, including the generated result, in the second level of the history buffer;
responsive to instruction completion and identification of pre-transactional memory data contained in the first instruction, move the first instruction from the second level to the third level of the history buffer, the moved first instruction including pre-transactional memory data;
responsive to movement of the first instruction to the second level of the history buffer, invalidate the entry of the first instruction in the first level of the history buffer; and
responsive to movement of the first instruction to the third level of the history buffer, invalidate the entry of the first instruction in the second level of the history buffer.

2. The CPU of claim 1, wherein the third level of the history buffer comprises one entry per logical register (LREG).

3. The CPU of claim 2, further comprising when pre-TM data is moved from the second level to the third level of the history buffer, the HB controller to use the LREG of the associated instruction as an index address to write into the third level.

4. The CPU of claim 3, further comprising the HB controller to set a pre-TM identifier of the entry in the third level to indicate the LREG is a pre-TM entry to be restored responsive to a transaction failure.

5. The CPU of claim 4, further comprising the HB controller to clear out all the pre-TM identifiers in the third level if the transaction passes.

6. The CPU of claim 4, further comprising program instructions to restore all entries in the third level with the set pre-TM identifier to a general purpose register.

7. A computer program product for processing instructions responsive to a split history buffer of a central processing unit (CPU), the computer program product comprising a computer readable storage device having program code embodied therewith, comprising:
a history buffer and a history buffer (HB) controller;
the history buffer configured with multiple levels, including first, second, and third levels;
a register file and a register file (RF) controller;
the RF controller comprising program instructions to:
fetch a first instruction, tag the fetched first instruction, and allocate space for the first instruction in an entry of a register file;
fetch a second instruction, tag the fetched second instruction, evict the first instruction from the entry of the register file, and allocate space for the second instruction in the entry of the register file;
the HB controller comprising program instructions to:
store the first instruction in the first level of the history buffer;
responsive to generation of a result for the first instruction, move the first instruction from the first level of the history buffer, and store the first instruction, including the generated result, in the second level of the history buffer;
responsive to instruction completion and identification of pre-transactional memory data contained in the first instruction, move the first instruction from the second level to the third level of the history buffer, the moved first instruction including pre-transactional memory data;
responsive to movement of the first instruction to the second level of the history buffer, invalidate the entry of the first instruction in the first level of the history buffer; and
responsive to movement of the first instruction to the third level of the history buffer, invalidate the entry of the first instruction in the second level of the history buffer.

8. The computer program product of claim 7, wherein the third level of the history buffer comprises one entry per logical register (LREG).

9. The computer program product of claim 8, further comprising when pre-TM data is moved from the second level to the third level of the history buffer, program instructions to use the LREG of the associated instruction as an index address to write into the third level.

10. The computer program product of claim 9, further comprising program instructions to set a pre-TM identifier of the entry in the third level to indicate the LREG is a pre-TM entry to be restored response to a transaction failure.

11. The computer program product of claim 10, further comprising program instructions to clear out all the pre-TM identifiers in the third level if the transaction passes.

12. The computer program product of claim 10, further comprising program instructions to restore all entries in the third level with the set pre-TM identifier to a general purpose register.

13. A method for processing instructions responsive to a split history buffer of a central processing unit (CPU) comprising:
configuring a history buffer with multiple levels, including first, second, and third levels;
fetching a first instruction, tagging the fetched first instruction, and allocating space for the first instruction in an entry of a register file;
fetching a second instruction, tagging the fetched second instruction, evicting the first instruction from the entry of the register file, allocating space for the second instruction in the entry of the register file, and storing the first instruction in the first level of the history buffer;
responsive to generating of a result for the first instruction, moving the first instruction from the first level of the history buffer, and storing the first instruction, including the generated result, in the second level of the history buffer;
responsive to instruction completion and identification of pre-transactional memory data contained in the first instruction, moving the first instruction from the second level to the third level of the history buffer, the moving first instruction including pre-transactional memory data;
responsive to movement of the first instruction to the second level of the history buffer, invalidating the entry of the first instruction in the first level of the history buffer; and
responsive to movement of the first instruction to the third level of the history buffer, invalidating the entry of the first instruction in the second level of the history buffer.

14. The method of claim 13, wherein the third level of the history buffer comprises one entry per logical register (LREG).

15. The method of claim 14, further comprising when pre-TM data is moved from the second level to the third level of the history buffer, using the LREG of the associated instruction as an index address to write into the third level.

16. The method of claim 15, further comprising setting a pre-TM identifier of the entry in the third level to indicate the LREG is a pre-TM entry to be restored response to a transaction failure.

17. The method of claim 16, further comprising clearing out all the pre-TM identifiers in the third level if the transaction passes.

18. The method of claim 16, further comprising restoring all entries in the third level with the set pre-TM identifier to a general purpose register.
